(19) United States
(12) Patent Application Publication
(10) Pub. No.: US 2006/0208505 A1
(43) Pub. Date: Sep. 21, 2006

(54) Locking mechanism for a vehicle seat

(75) Inventors: Thomas Christoffel, Herschweiler-Pettersheim (DE); Carsten Baumchen, Oberthal (DE)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(73) Assignee: KEIPER GmbH & Co. KG

(21) Appl. No.: 11/438,983

(22) Filed: May 23, 2006

Related U.S. Application Data
(63) Continuation of application No. PCT/EP04/13699, filed on Dec. 2, 2004.

(30) Foreign Application Priority Data
Jan. 12, 2004 (DE) 10 2004 001 766.2

(51) Int. Cl. E05C 3/06

(52) U.S. Cl. 292/216

(57) ABSTRACT

In the case of a locking mechanism (1), in particular for a vehicle seat, with a housing (3) having a base plate (5), a latch (1) which is arranged in the housing (3), is mounted pivotably and is intended for latching with a mating element (B), and at least one securing element (25, 27), which is likewise arranged in the housing (3), is mounted pivotably and, by interaction with the latch (11), secures a locked state, the outer side of the base plate (5) is designed as a panel and/or covering.

### CROSS-REFERENCE TO RELATED APPLICATION

The present application is a continuation of International Application PCT/EP2004/013699, which was filed Dec. 2, 2004. The entire disclosure of PCT/EP2004/013699 is incorporated herein by reference.

### BACKGROUND OF THE INVENTION

The present invention relates to a locking mechanism for a vehicle seat, in particular for a motor vehicle seat, having a housing with a base plate, a pivotably mounted latch that is positioned in the housing for latching with a mating element, and at least one pivotably mounted securing element that is positioned in the housing for interacting with the latch to secure a locked state.

In the case of a known locking mechanism of the type described immediately above, the latch and two securing elements are arranged within a substantially closed, metallic housing. The housing is fastened to a structural part of the vehicle seat or of the motor vehicle, and is covered by a plastic panel clipped onto the outer side of the base plate.

### BRIEF SUMMARY OF SOME ASPECTS OF THE INVENTION

An aspect of the present invention is the provision of improvements to a locking mechanism of the type described above. In accordance with an aspect of the present invention, a locking mechanism for a vehicle seat, in particular for a motor vehicle seat, includes a housing having a base plate, a pivotably mounted latch for latching with a mating element, and at least one pivotably mounted securing element for interacting with the latch to secure a locked state. The at least one securing element and the latch are at least partially contained by the housing. An outer side of the base plate is designed as a panel and/or cover.

Because the outer side of the base plate is designed as a panel and/or cover, a separately designed panel does not need to be fitted in order to conceal the technically expediently formed components and open cavities. Not having to clip on the separately designed panel reduces the number of components required, simplifies the installation and reduces the costs. Furthermore, the service life is increased, and an interface (e.g., such as between the prior separately designed panel and the prior housing) is not required. The outer side of the base plate is to be understood as meaning the visible side of the base plate, which side faces away from the structural part to which the locking mechanism is to be fastened.

The base plate can be adapted in its panel function in a particularly simple and cost-effective manner to the requirements and customer's desires if, in a preferred embodiment, the base plate is formed from plastic. However, it may also be composed of another soft, moldable material, for example of brushed aluminum. If a reinforcement is required, the base plate may have an insert of a higher strength material, preferably of steel, which, for example, is encapsulated by the plastic by injection molding. As a further reinforcement, a coupling plate may be placed onto the bearing elements for the latch and the securing elements. In order to improve its panel function, the (visible) outer side of the base plate is designed as a visible surface, i.e. is designed in terms of color, shape and surface structure to be visually more attractive than a technically expedient outer skin. For example, the outer side of the base plate is embossed and/or colored and/or painted.

The housing preferably has a side wall that protrudes from the base plate, is preferably formed as a single piece with it, is spaced apart from the outer edges of the base plate and is offset inward. The side wall encloses, in a manner saving on construction space, the region predetermined by the latch, the securing elements and the pivoting regions thereof, whereas the shape of the base plate can be matched to the application (for example the base plate can be generally rectangular). The region between the outer edges of the base plate and the side wall is then used merely to improve the panel function of the base plate.

In a preferred embodiment, the housing is of half-open design, and a structural part, to which the locking mechanism is to be fastened, closes the housing. As a result, a separate lid does not have to be provided, which saves material, weight and construction space and, in particular, avoids unnecessary doublings of material. The locking mechanism, which is preferably already operative and testable for normal use and is open toward one side, obtains its full strength, in particular with regard to the loads in the event of a crash, by attachment to the structural part. At the same time, the components within the locking mechanism are protected from damage and dirt by the housing being closed.

The bearing elements for the latch and the securing elements can be provided on the housing or on a separately formed bearing plate which closes the housing, for example as a type of lid.

In the case of a locking mechanism with increased locking reliability and increased load-bearing capacity in the event of a crash, a clamping eccentric and an intercepting component are provided as the securing elements. In the locked state, the spring-loaded clamping eccentric acts upon the latch with a closing moment. The intercepting component supports the latch in the event of a crash.

The locking mechanism according to the invention can be used at different points of a vehicle seat, for example for connecting the entire vehicle seat to the floor or as a backrest lock for fastening the backrest to the vehicle structure, with the locking mechanism being attached to a structural part fixed on the seat structure or a structural part fixed on the vehicle structure, and the mating element correspondingly being fixed to the vehicle structure or fixed to the seat structure. The locking mechanism may also be integrated in an articulated fitting which is provided for setting the inclination of the backrest, in particular if one of the fitting parts is to be designed as a hollow box.

Other aspects and advantages of the present invention will become apparent from the following.

### BRIEF DESCRIPTION OF THE DRAWINGS

The present invention is explained in greater detail below with reference to an exemplary embodiment and a modification which are illustrated in the drawings, in which:

FIG. 1 is a side view of the inner side of the exemplary embodiment,

FIG. 2 is a side view of the outer side of the exemplary embodiment,

FIG. 3 is a plan view of the exemplary embodiment,

FIG. 4 is an exploded illustration of the exemplary embodiment, and

FIG. 5 is a section through the modification of the exemplary embodiment.

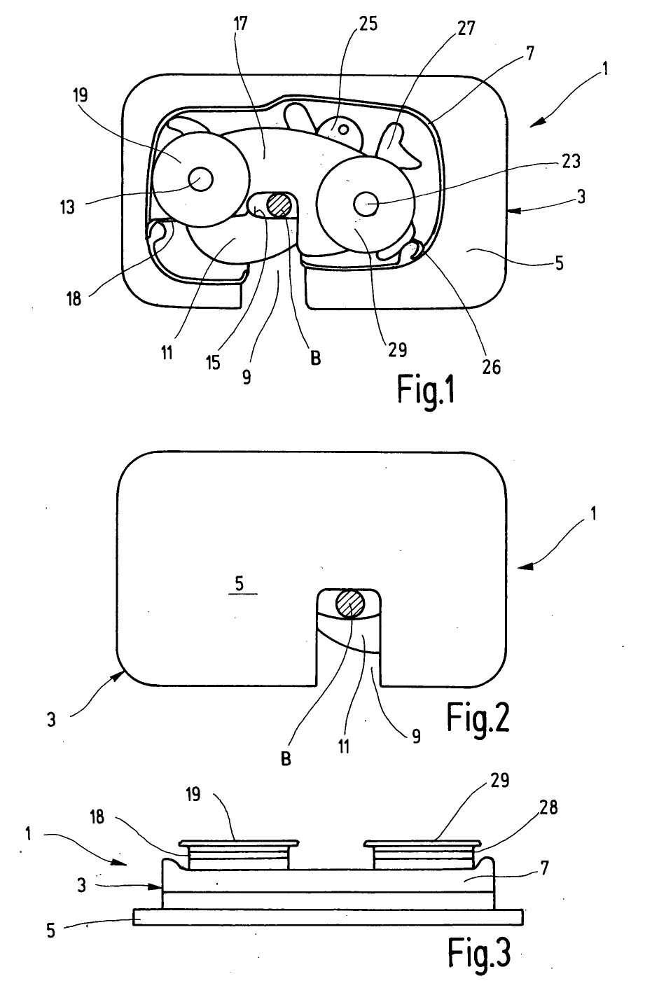

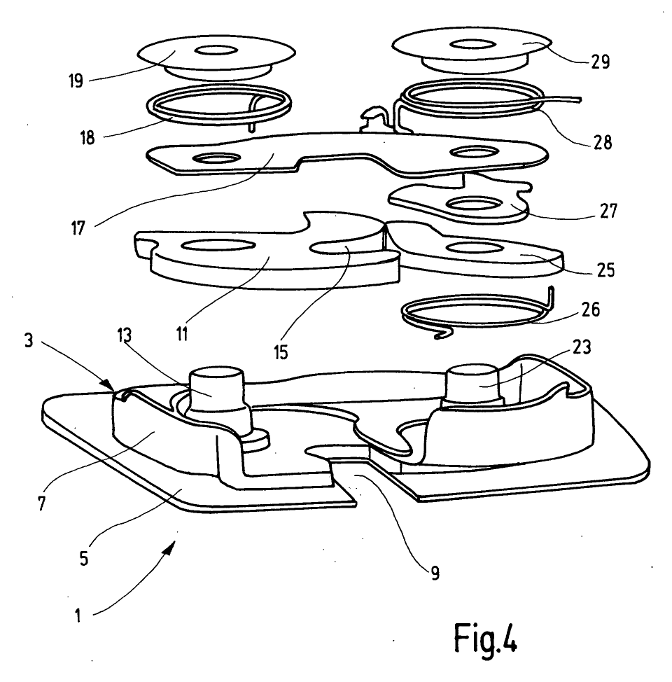

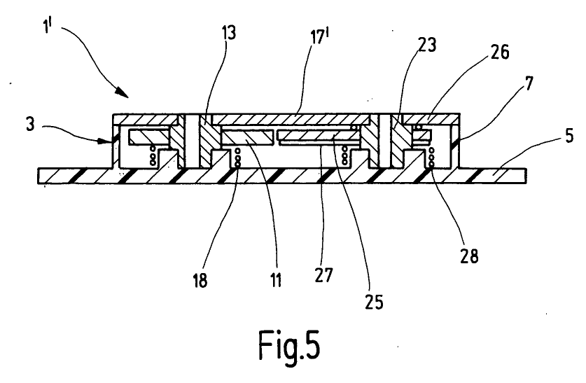

### DETAILED DESCRIPTION OF EXEMPLARY EMBODIMENT

A locking mechanism 1 is provided for releasably connecting a backrest of a vehicle seat to the vehicle structure of a motor vehicle. The locking mechanism 1 could also be used for connecting a vehicle seat to the floor, or as a hood or tailgate lock. The locking mechanism 1 has a half-open plastic housing 3 with a base plate 5. The base plate 5 is generally rectangular, and has an outer side that is flat. The base plate 5 is oriented vertically and in the direction of travel and defines the directional indications used below. The base plate 5 can optionally be provided with an insert that is inserted into the base plate 5 and constructed of steel or another material of higher strength in comparison to the plastic. Protruding perpendicularly from the base plate 5 is a side wall 7 that is formed as a single piece with the base plate 5, is spaced apart from/offset inwardly from the outer edges of the base plate 5, and encloses a region for receiving components as described below. A bolt receptacle 9 is formed on one longitudinal side of the housing 3. The bolt receptacle 9 opens outward and serves to receive a bolt B fixed to the vehicle structure, or another mating element. In this case, the width of the bolt receptacle 9 is larger than the diameter of the bolt B in order to compensate for tolerances. The mating element may also be a section of a clip.

A latch 11 is pivotably mounted on a first bearing element 13 that protrudes from the base plate 5 and extends parallel to the side wall 7. The first bearing element 13 is integrally formed on the housing 3, or the first bearing element 13 is connected to the housing 3 as a separately formed bolt. In order to fasten the locking mechanism 1, the first bearing element 13 is preferably of hollow design. For interaction with the bolt B, the latch 11 has a hook mouth 15. In a locked state of the locking mechanism 1, the hook mouth 15 extends across the bolt receptacle 9 at least approximately perpendicularly and closes it. In an open state of the locking mechanism 1, the hook mouth 15 is positioned so that the bolt receptacle 9 is open.

A coupling plate 17 is pushed onto the first bearing element 13. The coupling plate 17 is parallel to the base plate 5 and to the pivoting plane of the latch 11. The first bearing element 13 preferably has a shoulder that functions as a stop during the pushing-on of the coupling plate 17. On that side of the coupling plate 17 which faces away from the latch 11, a first torsion spring 18 is arranged on the first bearing element 13. The first torsion spring 18 acts upon the latch 11 with an opening moment. A first plastic retaining ring 19 is pushed, in particular pressed, onto the free end of the first bearing element 13 as far as the coupling plate 17. The first retaining ring 19 secures the latch 11 in the axial direction. A flange is integrally formed on the first retaining ring 19 on the side facing away from the latch 11.

A second bearing element 23 of basically identical design to the first bearing element 13 is integrally formed on the housing 3, or is connected thereto, at a distance from the first bearing element 13. An intercepting component 25 is pivotably mounted on the second bearing element 23 and is prestressed in the direction of the latch 11 by means of a second torsion spring 26. The second torsion spring 26 is arranged between the base plate 5 and the intercepting component 25. Toward that side of the intercepting component 25 which faces away from the base plate 5, a clamping eccentric 27 is mounted on the second bearing element 23. The clamping eccentric 27 is prestressed by a third torsion spring 28 so that the clamping eccentric 27 acts upon the latch 11 in the locked state with a closing moment and, as a result, keeps the latch in engagement with the bolt B.

As with the first bearing element 13, the coupling plate 17 is pushed onto the second bearing element 23, the second bearing element 23 preferably likewise having a shoulder that functions as a stop. A third torsion spring 28 is interposed between the coupling plate 17 and a second retaining ring 29. The second retaining ring 29 is pushed, in particular pressed, onto the free end of the second bearing element 23 as far as the coupling plate 17. The second retaining ring is similar to the first retaining ring 19, i.e. also being composed of plastic and having an integrally formed flange. The second retaining ring 29 secures the clamping eccentric 27 and the intercepting component 25 in the axial direction.

In the normal situation, the intercepting component 25 is arranged at a distance from the latch 11. In the event of a crash, if the latch 11 experiences an opening moment and presses the clamping eccentric 27 away, the latch 11 comes to bear against the intercepting component 25, which supports the latch 11 and prevents it from opening. To unlock the locking mechanism 1, the intercepting component 25 is pivoted away from the latch 11 in a manner known per se, for example via an integrally formed unlocking bolt, a lever or a Bowden cable, with the intercepting component using an integrally formed driver to carry along the clamping eccentric 27, if appropriate after a small empty stroke. The latch 11 is then no longer secured and is pulled up by the first torsion spring 18 and held up by the intercepting component 25 in the unlocked state. The clamping eccentric 27 and the intercepting component 25 are therefore securing elements for the latch 11 both in the locked and in the open state.

With the components described above, the locking mechanism 1 is already operative for normal use, i.e forms a testable unit, even if the housing 3 is still open. In order to achieve full strength in the event of a crash, a structural part, to which the locking device 1 is to be fastened, largely closes the housing 3 and at the same time reinforces the bearing points, with the structural part bearing against the ends of the bearing elements 13 and 23.

According to the invention, the base plate 5 serves not only to form the housing 3 but also at the same time as a panel and covering on the outer side. For this purpose, depending on the application and customer's requirements, the housing 3 can be embossed or textured in some other manner, colored in, painted or designed in any desired combination thereof, in particular in the region of the outer side, which is designed as the visible surface of the base plate 5. Depending on the load requirement, the housing 3 may be provided without an insert and/or may be composed of a plurality of plastic components, with the result that the functional regions (bearing points) have a different composition from the panel and covering regions.

In a modification, which is identical to the exemplary embodiment, unless otherwise described, instead of the coupling plate 17 and the retaining rings 19 and 29, the locking mechanism 1′ is provided with a bearing plate 17′ which is formed separately from the housing 3 and to which the bearing elements 13 and 23 are fastened, for example are pressed in. At the same time, the bearing plate 17′ closes the housing 3 in the manner of a lid. The housing 3 with the base plate 5 then no longer has the bearing function but rather just the panel and covering function.

It will be understood by those skilled in the art that while the present invention has been discussed above with reference to exemplary embodiments, various additions, modifications and changes can be made thereto without departing from the spirit and scope of the invention as set forth in the following claims.

What is claimed is:

1. A locking mechanism for use with a mating element, the locking mechanism comprising:
a housing including a base plate;
a pivotably mounted latch for latching with the mating element; and
at least one pivotably mounted securing element for interacting with the latch in a manner that seeks to maintain a locked state of the locking mechanism, wherein
the at least one securing element and the latch are at least partially contained by the housing,
the base plate includes an outer side, and
the outer side of the base plate is configured for being at least one of
a) a panel, and
b) a cover.

2. The locking mechanism as claimed in claim 1, wherein the base plate is at least partially formed from a material selected from the group consisting of plastic and aluminum.

3. The locking mechanism as claimed in claim 2, wherein:
the material is a first material,
the base plate includes an insert formed from a second material, and
the second material has a higher strength than the first material.

4. The locking mechanism as claimed in claim 1, wherein the outer side of the base plate being configured for being at least one of a panel and a cover comprises:
the outer side of the base plate being at least one of
a) embossed,
b) colored, and
c) painted.

5. The locking mechanism as claimed in claim 1, wherein:
the base plate includes outer edges,
the housing includes a side wall that protrudes from the base plate,
the side wall is spaced apart from the outer edges of the base plate, and
the side wall being spaced apart from the outer edges of the base plate comprises the side wall being inwardly offset from the outer edges of the base plate.

6. The locking mechanism as claimed in claim 5, wherein the base plate and the side wall together are a single piece.

7. The locking mechanism as claimed in claim 5, wherein the base plate is generally rectangular, and the at least one securing element and the latch being at least partially contained by the housing comprises:
the side wall extending at least partially around a region, and
the latch and the at least one securing element being positioned in the region that the side wall extends at least partially around.

8. The locking mechanism as claimed in claim 1, further comprising a coupling plate, wherein:
the housing includes
a) a first bearing element for the latch, and
b) a second bearing element for the at least one securing element; and
the coupling plate is positioned on the first and second bearing elements.

9. The locking mechanism as claimed in claim I in combination with a structural part, wherein:
the base plate defines a first side of the housing,
the housing includes a second side that is opposite from the first side,
the second side includes an opening, and
the locking mechanism is fastened to the structural part so that the structural part closes the opening.

10. The locking mechanism as claimed in claim 1, further comprising a bearing plate formed separately from the housing, wherein:
a first bearing element, which is for the latch, is provided on the bearing plate, and
a second bearing element, which is for the at least one securing element, is provided on the bearing plate.

11. The locking mechanism as claimed in claim 1, wherein the at least one securing element comprises:
a spring-loaded clamping eccentric for acting upon the latch with a closing moment during the locked state, and
an intercepting component for supporting the latch in the event of a crash.

12. The locking mechanism as claimed in claim 1, wherein:
the base plate is at least partially formed from a material having a lower strength than steel; and
the outer side of the base plate being configured for being at least one of a panel and a cover comprises the outer side of the base plate being at least one of
a) embossed,
b) colored, and
c) painted.

13. The locking mechanism as claimed in claim 12, wherein:
the base plate includes outer edges,
the housing includes a side wall that extends away from the base plate,
the side wall is spaced apart from the outer edges of the base plate, and
the side wall being spaced apart from the outer edges of the base plate comprises the side wall being inwardly offset from the outer edges of the base plate.

14. The locking mechanism as claimed in claim 6, wherein the base plate is generally rectangular, and the at least one securing element and the latch being at least partially contained by the housing comprises:
the side wall extending at least partially around a region, and
the latch and the at least one securing element being positioned in the region that the side wall extends at least partially around.

15. The locking mechanism as claimed in claim 5, further comprising a coupling plate, wherein:
the housing includes
a) a first bearing element for the latch, and
b) a second bearing element for the at least one securing element; and
the coupling plate is positioned on the first and second bearing elements.

16. The locking mechanism as claimed in claim 5, wherein:
the base plate defines a first side of the housing,
the housing includes a second side that is opposite from the first side,
the second side includes an opening, and
the opening is obstructed.

17. A locking mechanism for use with a mating element, the locking mechanism comprising:
a housing including
a) a base plate having first and second outer edges that are opposite from one another and spaced apart from one another in a direction, and
b) a side wall that extends away from the base plate, wherein the side wall extends at least partially around an area that is adjacent to at least a central portion of the base plate, a first portion of the side wall is closer than all other portions of the side wall to the first outer edge of the base plate, and all of the first portion of the sidewall is spaced apart from the first outer edge of the base plate in said direction so that
1) all of the first portion of the side wall is inwardly offset in said direction from the first outer edge of the base plate, and
2) the first outer edge of the base plate is positioned outwardly away from all of the first portion of the side wall; and
a latch that is pivotably mounted to a first bearing element, is at least partially within the area, and is for latching with the mating element; and
at least one securing element that is pivotably mounted to a second bearing element, is at least partially within the area, and is for interacting with the latch in a manner that seeks to maintain a locked state of the locking mechanism.

18. The locking mechanism as claimed in claim 17, further comprising a second plate positioned on the first and second bearing elements.

19. The locking mechanism as claimed in claim 17, wherein the base plate, the side wall, the first bearing element and the second bearing element all together are a single piece.

20. The locking mechanism as claimed in claim 17, wherein the base plate defines a receptacle that is for having the mating element extend therethrough while the latch is locked to the mating element.
